(19) United States
(12) Patent Application Publication
(10) Pub. No.: US 2020/0160330 A1
(43) Pub. Date: May 21, 2020

(54) LIGHTWEIGHT BLOCKCHAIN SUPPORTED TRANSACTION PLATFORM WITH PROOF-OF-TWO CONSENSUS AND CENTRALIZED IDENTIFICATION MANAGEMENT

(71) Applicant: TraDove, Inc., Palo Alto, CA (US)

(72) Inventor: Jun Yan, Palo Alto, CA (US)

(21) Appl. No.: 16/198,741

(22) Filed: Nov. 21, 2018

(51) Int. Cl. G06Q 20/38; G06Q 20/40; G06F 16/182; H04L 9/06; H04L 9/08; H04L 9/32; G06Q 20/36

(52) U.S. Cl. CPC G06Q 20/3825; G06Q 20/4014; G06F 16/1824; G06F 16/1834; H04L 9/0643; H04L 2209/56; H04L 9/3247; G06Q 20/367; G06Q 20/405; H04L 2209/38; H04L 9/0861

(57) ABSTRACT

Systems and methods are provided for processing transactions in a blockchain supported network, including receiving a proposed block of data including a data structure comprising a representation of a transaction completed between a first network participant and a second network participant pursuant to a smart contract; applying a proof-of-two consensus rule to the proposed block of data to obtain a result; upon obtaining consensus from the first network participant and the second participant, adding the block of data onto only the respective blockchains of the first network participant and the second network participant such that the block representing the transaction between the first network participant and the second network participant is not viewable by the entire network of user nodes in the blockchain network, and wherein the consensus not obtained from a majority of user nodes in the blockchain supported network.

### TECHNICAL FIELD

This disclosure relates to blockchain transaction networks, and more specifically some embodiments disclosed herein relate to a lightweight blockchain supported transaction platform supporting proof-of-two consensus conditioned block modifications, abbreviated transaction ledgers, fiat pegged cryptocurrencies (also called tokens or coins), digital bills, smart contracts, and centralized identification management.

### BACKGROUND

A blockchain is generally understood to be a distributed database (e.g., a ledger) that can record transactions between parties in a verifiable manner. Conventional blockchain based platforms utilize such a decentralized digital ledger to record all transactions occurring within the network into blocks that are successively linked together using cryptography. Typically, each subsequent block in the chain includes a cryptographic hash of the previous block. In conventional blockchain systems, the entire ledger (including all transactions that have occurred within the network) is distributed to all the nodes in the network. The ledger is said to be immutable and transparent. In conventional systems, the blockchain cannot be altered without first obtaining consensus for the change by a majority of all the nodes in the network, based on traditional consensus protocols.

However, because conventional blockchain supported transaction platforms are all-network transparent, and because copies of the entire ledger (i.e., a ledger of all transactions between any and all participants within the blockchain network) are held by all the nodes in the network without respect to any particular node's participation in a transaction, they cannot meet the privacy requirements often desired in business-to-business transactions. In instances where a business may wish to keep its participation in a specific transaction with another party private from another party (or subset of other parties) on the same blockchain network, conventional blockchains fail. Furthermore, the all-encompassing ledger in conventional designs make the blockchain computationally cumbersome and unsustainable as the number of transactions grows. The sheer volume of anticipated transactions occurring across a given network will cause conventional blockchain supported transaction platforms to become even more bogged-down with the heavy computational workload, and left wanting for the computational power to make speedy and practical use of the platform. What's more, the cryptocurrencies (sometimes referred to herein as “coins”) often provided through conventional blockchain supported transaction platforms are incredibly volatile. Because these cryptocurrencies (e.g., Bitcoin, Ethereum, etc.) are of uncertain value relative to fiat currencies (i.e., not tied to fiat currency at a certain or predictable exchange rate), any presumed value in the cryptocurrency disappear in an instant.

### SUMMARY

A claimed solution rooted in computer technology overcomes problems specifically arising in the realm of computer technology—namely a double-spend problem in blockchain supported transaction platforms, computationally onerous blockchains, and privacy concerns, among others. A lightweight blockchain network platform is provided for creating, issuing, and controlling different types of transactions on a blockchain network system. The systems and methods presented herein ensure secure payments between network participants, while saving transactions and their validations only between the transaction participants. Thereby, privacy is obtained by limiting the visibility of the network and validating users through a centralized identity node. For example, a method presented by the present disclosure includes receiving a proposed block of data including a data structure comprising a representation of a transaction completed between a first network participant and a second network participant pursuant to a smart contract in a blockchain supported network; applying a proof-of-two consensus rule to the proposed block of data to obtain a result; obtaining a proof-of-two consensus among the first network participant and the second network participant; and linking, responsive to the obtained consensus, the block of data only onto a respective blockchain of the first network participant and the respective blockchain of a second network participant. In some embodiments, the consensus obtained is not from a majority of user nodes in the blockchain supported network.

Furthermore, the present disclosure provides a system for processing transactions in a blockchain supported network. The system may include one or more processors; and one or more memory devices storing instructions that, when executed by the one or more processors, cause the system to perform operations of: establishing a user node for each of a plurality of network participants, each user node comprising an authenticated ID and a digital wallet, the digital wallet configured to manage tokens acquired by the respective network participant associated with the user node; depositing, in exchange for a received amount of fiat currency and at a predetermined exchange rate, a number of disposable tokens into the digital wallet of the first network participant's user node in exchange for the received amount of fiat currency; providing a smart contract to facilitate a transaction between the first network participant and a second network participant, the smart contract comprising transaction terms, the transaction terms comprising a payment term, the payment term comprising an amount of fiat currency pegged coins; locking, upon receiving a required digital signature (or other forms of authorization) from the first network participant and a required digital signature (or other forms of authorization) from the second network participant, a number of tokens in the digital wallet of the first network participant's user node; releasing, upon receiving an indication of agreement from both the first network participant and the second network participant, the number of tokens from the digital wallet of the first network participant's user node to the digital wallet of the second network participant's user node. In some embodiments, the tokens persist within the system unless they are otherwise burned or expired.

In some embodiments such operations further include receiving a proposed block of data comprising a data structure comprising a representation of the transaction completed between the first network participant and the second network participant pursuant to the smart contract; and/or applying a proof-of-two consensus rule to the proposed block of data to obtain a result.

In some embodiments such operations further include receiving a number of tokens from the second network participant's user node; and/or depositing into an account associated with the second network participant, in exchange for the received amount of tokens from the second network participant's user node and at the predetermined exchange rate, an amount of fiat currency corresponding to the number of disposable tokens received from the second network participant's user node.

In some embodiments, the system is further configured such that the one or more memory devices store instructions that, when executed by the one or more processors, further cause the system to perform operations of: determining if the proposed block of data accurately reflects the occurrence of the transaction completed between the first network participant and the second network participant pursuant to the smart contract.

In some embodiments, the system is further configured such that the one or more memory devices store instructions that, when executed by the one or more processors, further cause the system to perform operations of: receiving, obtaining, and/or identifying an indication of consensus, wherein the indication of consensus signifies that two or more participating network participants applied the same proof-of-two consensus rule to the same proposed block of data and arrived at the same determination. In some instances the determination is that the proposed data block does indeed accurately reflect the occurrence of the transaction completed between the participating network participants (e.g., the first network participant and the second network participant) pursuant to the smart contract. In that event, the instructions may further cause the system to perform the operations of: linking the proposed block of data onto a prior block of data using a hash generated by a hashing algorithm, the hash based at least in part on the prior block of data.

In some embodiments, the system is further configured such that the one or more memory devices store instructions that, when executed by the one or more processors, further cause the system to perform operations of: generating a block of data comprising a data structure comprising a representation of the transaction completed between the first network participant and the second network participant pursuant to the smart contract; and/or applying a hash algorithm to a subset of information, the subset of information comprising a hash value of a previously generated block of data. In some embodiments, the subset of information further includes a transaction parameter of the transaction completed between the first network participant and the second network participant pursuant to the smart contract.

In another example, a method presented by the present disclosure includes: establishing an account for each of a plurality of network participants, each account comprising an authenticated ID and a digital wallet, the digital wallet configured to manage tokens acquired by the respective network participant associated with the account; receiving an amount of fiat currency from a first network participant; depositing, in exchange for the received amount of fiat currency and at a predetermined exchange rate, a number of tokens into the digital wallet of the first network participant in exchange for the received amount of fiat currency; providing a smart contract to facilitate a transaction between the first network participant and a second network participant, the smart contract comprising transaction terms, the transaction terms comprising a payment term, the payment term comprising an amount of currency, wherein the amount of currency is given in one or more of fiat currency units or token units (including, in some embodiments, a symbolic indication of the type of currency, e.g., the “$” symbol for US dollar fiat currency, or any symbol (“[symbol]”) designating a unit of token currency); determining, based on the payment term, a number of disposable tokens to be moved from the first network participant's digital wallet into the second network participant's digital wallet to complete the transaction; locking, upon receiving a required digital signature or other forms of authorization from the first network participant and a required digital signature or other forms of authorization from the second network participant, a number of tokens in the digital wallet of the first network participant, the number of tokens locked being sufficient to satisfy the payment term of the smart contract; releasing, upon receiving an indication of consensus from both the first network participant and the second network participant, a number of disposable tokens sufficient to satisfy the payment term of the smart contract from the digital wallet of the first network participant to the digital wallet of the second network participant; and/or unlocking, upon completion of the release of the tokens to the digital wallet of the second network participant, the tokens in the digital wallet of the second network participant.

In some embodiments, methods of the present disclosure may include receiving a number of tokens from the second network participant; and/or depositing into an account associated with the second network participant, in exchange for the received amount of tokens from the second network participant and at the predetermined exchange rate, an amount of fiat currency corresponding to the number of disposable tokens received from the second network participant.

In some embodiments, methods of the present disclosure may include receiving or creating a proposed block of data comprising a data structure comprising a representation of the transaction completed between the first network participant and the second network participant pursuant to the smart contract; applying a proof-of-two consensus rule to the proposed block of data to obtain a result; and/or determining if the proposed block of data accurately reflects the occurrence of the transaction completed between the first network participant and the second network participant pursuant to the smart contract.

In some embodiments, methods of the present disclosure may include receiving, obtaining, and/or identifying an indication of consensus, wherein the indication of consensus signifies that two or more participating network participants applied the the same proof-of-two consensus rule to the same proposed block of data and arrived at the same determination; wherein in some instances the determination is that the proposed data block accurately reflects the occurrence of the transaction completed between the participating network participants (e.g., the first network participant and the second network participant pursuant to the smart contract).

In some embodiments, methods of the present disclosure may further include linking the proposed block of data onto a prior block of data using a hash generated by a hashing algorithm, the hash based at least in part on the prior block of data.

In some embodiments, methods of the present disclosure may include generating a block of data comprising a data structure comprising a representation of the transaction completed between the first network participant and the second network participant pursuant to the smart contract; applying a hash algorithm to a subset of information, the subset of information comprising a hash value of a previously generated block of data; and wherein the subset of information further includes a transaction parameter of the transaction completed between the first network participant and the second network participant pursuant to the smart contract.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates one or more elements of a blockchain network environment in accordance with one or more embodiments of the present disclosure.

FIG. 2 is a diagram illustrating an example architecture of components of a UNode in accordance with one or more embodiments of the present disclosure.

FIG. 3 is a diagram illustrating an example architecture of components of an INode in accordance with one or more embodiments of the present disclosure.

FIG. 4 is an simplified block diagram illustrating an example relationship and process flow that may be implemented to facilitate a transaction between network participants associated with two different UNodes, in accordance with one or more embodiments of the present disclosure.

FIG. 5 illustrates an example data structure representation of the first two blocks in a node-specific blockchain.

FIG. 6 illustrates one or more elements of a blockchain network environment in accordance with one or more embodiments of the present disclosure, and further illustrates a simplified view of the blockchains maintained by individual user nodes within such a blockchain networking environment.

FIG. 7 illustrates an operational flow diagram illustrating an example method that may be implemented to in accordance with one or more embodiments of the present disclosure.

FIG. 8 illustrates an operational flow diagram illustrating an example method that may be implemented to in accordance with one or more embodiments of the present disclosure. (also include down payment and penalty process)

FIG. 9 illustrates an operational flow diagram illustrating an example method that may be implemented to in accordance with one or more embodiments of the present disclosure.

FIG. 10 is an example computing device that may be used to implement various features of embodiments described in the present disclosure.

The figures are not exhaustive and do not limit the present disclosure to the precise form disclosed.

### DETAILED DESCRIPTION

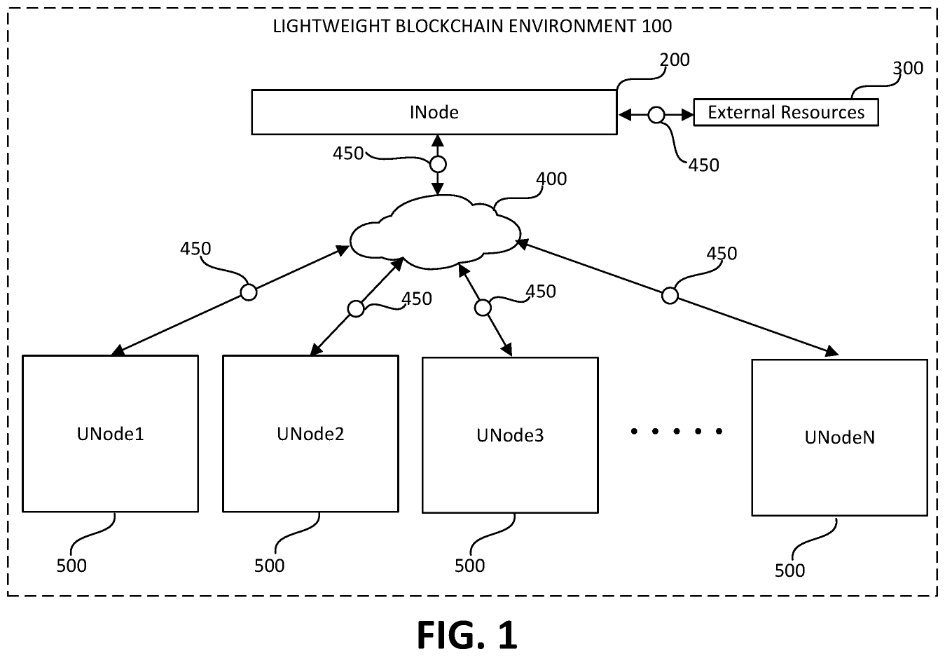

FIG. 1 is a diagram illustrating an example blockchain networking environment in which one or more embodiments of the present disclosure may be implemented. Blockchain networking environment 100 may include a plurality of nodes in communication with one another over network 400 via communication links 450. A “node” refers to any device that participates in a blockchain network. A node can comprise or be coupled with any active electronic device, such as, by way of example, laptop or desktop computers, smartphones, servers, tablets, netbooks, or even printers and other simple electronic devices. Nodes are coupled to or equipped with wired or wireless communication components allowing them to connect to and communicate with other Nodes over network 400, such as, by way of example, communication with other nodes over network 400 (e.g., over the Internet using an Ethernet, Wi-Fi, or Cellular connection, for example).

As shown, the nodes of blockchain networking environment 100 include multiple user nodes, UNode1, UNode2, . . . UNodeN communicatively coupled with one or more identity nodes, INode 200, the INode being further communicatively coupled with one or more external resources 300.

An INode (i.e., an “identity node”) is a node that is associated with a centralized identity verification and account management entity (e.g., TraDove), and a UNode (i.e., an “user node”) is a node that is associated with a network participant (e.g., a business, an organization, an institution, a person, an entity, or other user). For example, INode 200 may be embodied in one or more computer systems associated with a financial institution (e.g., a bank), and each UNode 500 may be embodied in one or more computer systems associated with a potential transactor on the network (e.g., potential buyers and potential sellers).

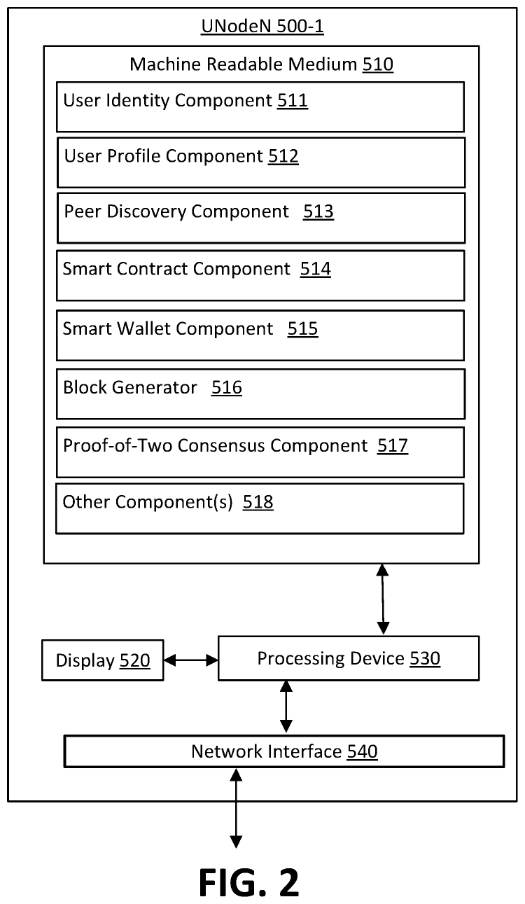

A UNode is configured to support the blockchain network embodiments of the present disclosure by maintaining a node-specific copy or partial copy of a blockchain (e.g., a copy of a blockchain that corresponds only to the transactions made by and with the network participant associated with that UNode). As described further with reference to FIGS. 2-10, a UNode is configured to check new transactions to be added to its blockchain using a novel Proof-Of-Two consensus protocol in accordance with one or more embodiments of the present disclosure. In some instances, a UNode can be configured to process transactions. Individual UNodes 500 may be embodied in one or more computer systems associated with individual network participants, where network participants are entities registered with blockchain network 100, and who may, upon satisfying requirements, participate in transactions with other network participants on a transaction platform supported by the blockchain network 100. In connection with the technology presented by the present disclosure, respective roles and functionality of the INode 200 and individual UNodes 500 in the blockchain network are discussed in further detail with respect to FIGS. 2-10.

Individual UNodes 500 may be embodied in computer systems associated with individual network participants, where network participants are entities registered with blockchain network 100, and who may, upon satisfying requirements, participate in transactions with other network participants on a transaction platform supported by the blockchain network 100.

Communication links 450 may connect nodes and/or other resources within blockchain networking environment 100 to network 400, and thereby to each other. Communication links 450 may be dynamically reconfigurable such that new nodes and/or other resources may be connected to or removed from the blockchain networking environment 100 as the network evolves with new and/or different participants, and new and/or different resources. Communication links 450 may include any type of link. For example, one or more links 450 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), optical (such as for example Synchronous Optical Network (SONET) or Synchronous Digital Hierarchy (SDH)) links, or any one or more of an ad hoc network, an intranet, an extranet, a VPN, a LAN, a WLAN, a WAN, a WWAN, a MAN, a portion of the Internet, a portion of the PSTN, a cellular technology-based network link, a satellite communications technology-based network link, another link 450, or a combination of two or more such links 450. Links 450 need not be the same throughout blockchain networking environment 100. Indeed, one or more first links 450 may differ in one or more respects from one or more second links 450. Communication over links 450 may include any request to send or receive any type of information accessible within blockchain networking environment 100.

Network 400 may include any type of communication network. As an example and not by way of limitation, one or more portions of network 400 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these.

In connection with the technology presented by the present disclosure, respective roles and functionality of INode 200 and individual UNodes 500 in the blockchain network will be discussed in further detail below with respect to FIGS. 2-10.

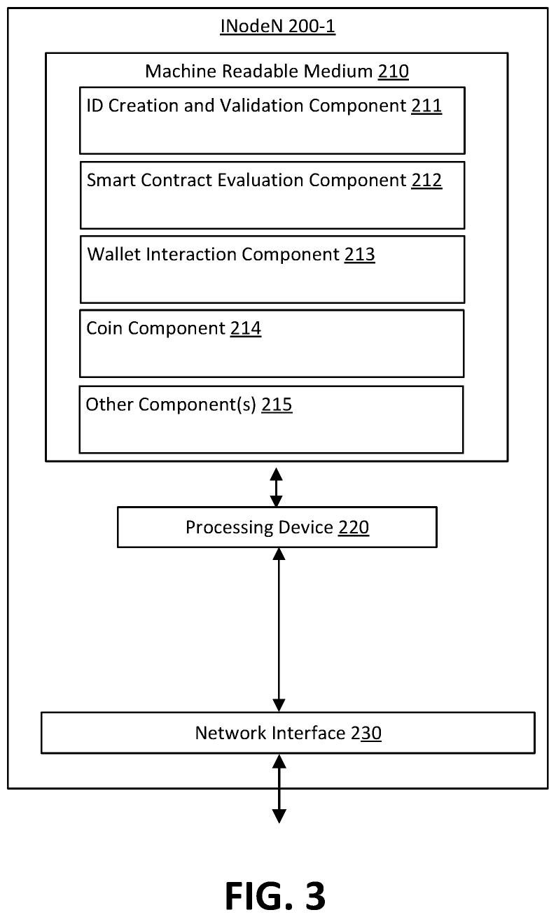

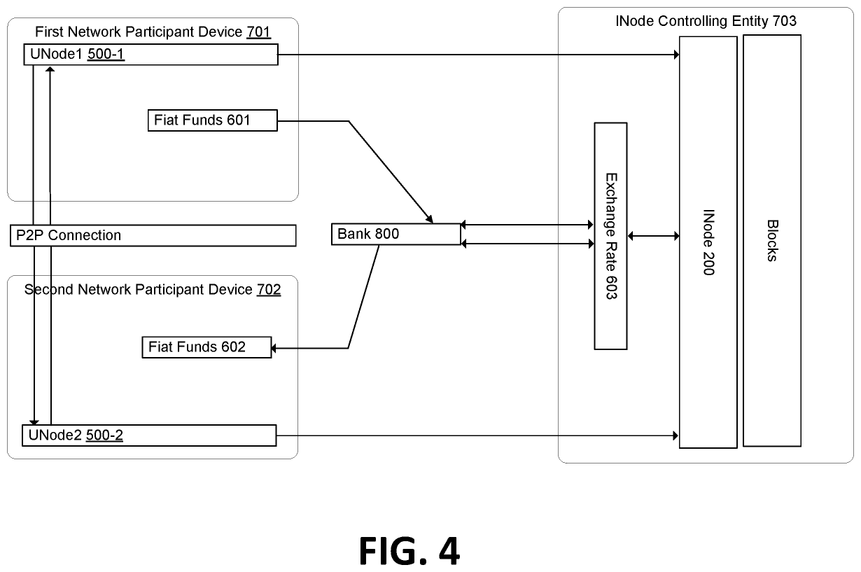

FIG. 2 is a diagram illustrating an example architecture of components of an example UNode 500-1, in accordance with one or more embodiments of the present disclosure. FIG. 3 is a diagram illustrating an example architecture of components of an example INode 200-1, in accordance with one or more embodiments of the present disclosure. Each component of the example UNode and example INode will be introduced here with reference to FIGS. 2-3, followed by additional features and context provided in examples discussed with reference to FIGS. 4-6.

Referring now to FIG. 2, UNodeN 500-1 may include a machine readable medium 510 having instructions stored thereon, which, when executed by one or more processors, cause one or more of the disclosed features to be effectuated. The machine readable medium may have machine readable code comprising a User Identity Component 511, User Profile Component 512, Peer Discovery Component 513, Smart Contract Component 514, Smart Wallet Component 515, Proof-of-Two Consensus Component 517, and/or Block Generator 516.

User Identity Component 511 acquires, stores, encrypts, and/or maintains identifying information associated with the particular network participant associated with the particular UNode. Such identifying information may include any static or dynamic information that, considered alone or taken together, is unique to a network participant among the plurality of network participants. By way of example, such identifying information may include (i) a unique user ID and/or password created during the network participant's registration with blockchain networking environment 100, (ii) a unique user ID and/or password associated with another service or platform that network participant subscribes to or maintains a membership with (e.g., LinkedIn, Instagram, Facebook, Gmail, Outlook, ABC Bank) and/or has concurrently (or within a predetermined period of time) accessed on the same computing device hosting the UNode, (iii) a serial number or electronic ID of the computing device hosting the UNode, (iv) real-time or previously measured digital fingerprint information, retinal scan information, face recognition, or other biometric information, (v) sensed information accessible to or through the computing device hosting the UNode associated with the network participant (e.g., GPS location information, temperature information, biometric information, audio/voice information, etc.), (vi) selected security questions and/or answers thereto, (vii) images, videos or other multimedia, (viii) a social security number, a date of birth, a government issued ID number (e.g., driver's license number, TaxID number), (ix) revenue information associated with the network participant, or anything else desired in the context of a transaction. One of skill in the art will appreciate that many other forms of identifying information may be acquired, stored, encrypted, and/or maintained by User Identity Component 511.

User Identity Component 511 may further create a unique hash identifier (“referred to herein as a NodeIDAddress) for the user that is based upon one or more pieces of such identifying information as an input to a hashing algorithm, or a unit of information assigned to the new network participant by the INode 200. During a network participant's initial registration with the blockchain network 100, INode 200 may create and digitally sign an initial entry and create a genesis block for the particular UNode 500 chain that is based, in whole or in part, on the NodeIDAddress. The signing of the initial entry by the INode 200 (e.g., using a cryptographic key) allows only the INode 200 to create and/or approve a genesis block within a new network participant's node-specific blockchain. In some instances the unique identifier may be assigned or provided as part of the node's participation in a blockchain transaction.

User Profile Component 512 receives input from a network participant (or an authorized representative of the network participant) regarding the appearance and content of a profile that may be searchable and viewable by peer network participants also registered to transact within blockchain networking environment 100. User Profile Component 512 may generate and/or make available for display, alone or in coordination with other resources within blockchain networking environment 100 (e.g., a server supporting INode 200), a digital profile that is searchable and/or viewable by peer network participants within the blockchain networking environment 100 (e.g., by searching a blockchain network participant database from an interface displayed through a display of a computing device hosting another UNode 500-1). User Profile Component 512 may also receive input or feedback from a peer networking participant in connection with the generated user profile. Such input or feedback may be provided for display on the network participant's user profile such that other peer networking participants can observe the input or feedback when viewing the network participants user profile. For example, input or feedback from a peer networking participant may include a rating concerning a prior transaction experience, a recommendation based on other information, a review, etc.). User Profile Component 512 may further monitor the network participant's activities (e.g., transactions) over the Network 400 (shown in FIG. 1), and generate, store, and/or make available for display information relating to such activities (e.g., transaction statistics, etc.).

Peer Discovery Component 513 provides, alone or in coordination with other resources within blockchain networking environment 100 (e.g., a server supporting INode 200), a search engine allowing a first network participant to search and view the User Profiles of other peer network participants who may be open to transacting business with the first network participant within the blockchain networking environment 100.

Smart Contract Component 514 may receive, create, and/or provide, alone or in coordination with other resources within blockchain networking environment 100 (e.g., a blockchain supported transaction platform running on a server supporting INode 200), a smart contract that can be shared with, digitally edited by, collaborated upon, and agreed to by multiple network participants. Smart Contract Component 514 may provide for display on an interface a user-friendly and human readable version of the smart contract, which may further include one or more fields and/or buttons for editing, modifying, accepting, rejecting, agreeing and/or digitally signing one or more provisions of a draft smart contract, and/or for providing a final approval for the automated execution of the smart contract once each network participant who is a party to the smart contract has satisfied all of the necessary terms. It will be appreciated that a “smart contract” as used herein comprises self-executing code residing on a blockchain network (e.g., on INode 200, one or more UNodes 500, or other blockchain network resource, or a combination of the foregoing), which, when executed effectuates completion of the associated transaction (e.g., it automatically executes a payment and/or delivery term of the contract) between trusted UNodes based on events that took place in connection with a blockchain supported transaction platform.

Smart Wallet Component 515 maintains and secures, alone or in coordination with other resources within blockchain networking environment 100 (e.g., a server supporting INode 200), a digital wallet owned by the network participant and associated with the given UNode. The digital wallet may include a network participants cryptocurrency holdings, blockchain network accounts, and private/public keys associated therewith. Smart Wallet Component 515 can be configured to provide management functionality, alone or in coordination with other resources within blockchain networking environment 100, such as transferring, converting, sending, receiving, releasing, exchanging, depositing, withdrawing, moving, securing or otherwise operating on cryptocurrency funds and/or fiat funds upon request. Smart Wallet Component 515 may further be configured to execute code to lock cryptocurrency coins, or allow a digitally signed smart contract to lock coins, in an amount sufficient to support the transaction described in the smart contract, etc. In some embodiments, Smart Wallet Component 515 may further be configured to execute code that causes the system to refund, release, receive, transfer, send, lock an amount of cryptocurrency to another network participant. In some embodiments, Smart Wallet Component 515 may further be configured to execute code to provide balance reporting after one or more transactions has occurred involving currency managed by the given Smart Wallet of a network participating, which may be accessible or viewable via a user device or other device within the blockchain networking environment. In some embodiments, Smart Wallet Component 515 may further be configured to facilitate back-up (e.g., periodic back-up, on demand back-up, or one-time back-up) for later restoration by a given network participant as needed (e.g., if the given network loses their digital wallet (e.g., loses their UNode device such as their smart phone)).

Block Generator 516 applies a hashing algorithm to an input to generate a proposed next block (a data structure shown in FIG. 3) for addition onto the blockchain. The input to the hashing algorithm includes the information from the most recently added block in the blockchain (including its cryptographic key), as well as the information for the one or more transactions that are claimed to have occurred after the most recent block was added to the chain. In some instances, the most recent block in the chain will be a genesis block (e.g., for new network participants). Blocks generated by Block Generator 516 will be added to the UNode 500-1's blockchain if consensus is reached pursuant to a Proof-of-Two Consensus protocol.

Proof-of-Two Consensus Component 517 (also referred to herein as “Po2” Consensus Component 517) comprises a predetermined consensus protocol which, when executed by a processor of the computing system hosting UNode 500-1, applies Po2 consensus rules to determine whether or not the transaction(s) represented by a proposed block actually occurred as represented. For example, when a block is proposed for addition to the blockchain, and the block includes one or more records of transactions claimed to have been executed in accordance with one or more smart contract of the present disclosure, the Po2 Consensus Component 517 at each UNode that was a party to the underlying transactions will apply the Po2 consensus rules to the proposed block to decide whether or not the underlying transactions represented by the proposed block are true/valid (i.e., that each UNode that was a party to the underlying transaction(s) sent and received what each intended to send and receive pursuant to the smart contract). Upon receiving unanimous acceptance/validation between the two UNodes associated with a two-party transaction, the Po2 consensus rules satisfied and the proposed block may be added to each participating UNode 500's blockchain. As such, the only blocks added to a particular UNode's blockchain are those that include transactions to which the particular UNode 500 was a party. Thereby, the version of the blockchain maintained by each UNode 500 is lightweight in that it involves far fewer and less complex blocks (on account of far fewer transactions), and fewer nodes executing less computationally intensive algorithms to arrive at a consensus before a block is added to a chain.

As further shown in FIG. 2, UNodeN 500-1 may be comprise or otherwise be operatively coupled with a display 520, a processing device 530, and a network interface 540. Display 520 may be any digital display that displays visual information based on instructions executed by a processor connected thereto. For example, display 520 may include touchscreen displays, computer monitor displays, television displays, etc. Processing device 530 may include one or more processors that performs processing operations or a combination of specialized and/or general-purpose processors that perform processing operations. For example, processing device 530 may include a CPU, GPU, APU, DSP, FPGA, ASIC, SOC, and/or other processing circuitry. Network interface 540 may be any communication circuit configured for communicating over a wired or wireless network. Network interface 540 provides a two-way data communication through network 400 over one or more communication links 450 (FIG. 1). For example, network interface 540 may be an integrated services digital network (ISDN) card, cable modem, satellite modem, a cellular chipset, or a modem to provide a data communication connection to a corresponding type of communication line. As another example, network interface 540 may be a local area network (LAN) card to provide a data communication connection to a compatible LAN (or WAN component to communicated with a WAN). Network interface 540 may send and receive electrical, electromagnetic, optical or other signals that carry digital data streams representing various types of information. It will be appreciated that one or more of display 520, processing device 530, and network interface 540 may be embodied in any type of computing device (e.g., a smartphone).

Referring now to FIG. 3, INode 200-1 may include a machine readable medium 210 having instructions stored thereon, which, when executed by one or more processors, cause one or more of the disclosed features to be effectuated. The machine readable medium may have machine readable code comprising a ID Creation and Validation Component 211, a Smart Contract Evaluation Component 212, a Wallet Interaction Component 213, a Coin Component 214, and/or one or more Other Component(s) 215.

ID Creation and Validation Component 211 receives information from prospective network participants, and if approved, registers a UNode into the blockchain networking environment that is associated with the approved prospective network participant, and a corresponding NodeIDAddress. For example, using a network participant's initial registration with the blockchain network 100, INode 200 may create and digitally sign an initial entry and create a genesis block for the particular UNode 500 chain that is based, in whole or in part, on the NodeIDAddress. The signing of the initial entry by the INode 200 (e.g., using a cryptographic key) allows only the INode 200 to create and/or approve a genesis block within a new network participant's node-specific blockchain. Further, whenever a registered UNode 500 requests to provide any input into the blockchain networking environment (e.g., a request to interact with another network participant in connection with a potential smart contract supported transaction, a request to modify or provide feedback concerning a user profile, etc.), ID Creation and Validation Component 211 may authenticate and/or validate the participant in any manner desired for the context of the request, for example, by using a single sign-on authentication, two-factor authentication, biometric authentication, active directory authentication, certificate-based authentication, NodeIDAddress authentication, or any other type of authentication of a centralized identity of the network participant. In some embodiments, authentication and/or validation procedures are facilitated only when a UNode user attempts to login to the network, but not for each and every transaction that a UNode participates in over the network after login. In some embodiments, authentication and/or validation procedures are facilitated on a per-transaction basis (e.g., authentication and/or validation procedures occurring each time a UNode attempts to participate in a transaction). Authentication may be performed in response to receiving input (e.g., credentials) from a computing device associated with a UNode 500 in the blockchain networking environment 100.

Smart Contract Evaluation Component 212 receives information about one or more terms in a smart contract that has been accepted and digitally signed by the parties, and if necessary instructs Wallet Interaction Component 213 to take an action, alone or in coordination with a given UNode's Smart Wallet Component 515. In some embodiments the one or more terms includes a payment term, and the action includes locking a number of coins in a UNode 500's digital wallet in an amount sufficient for the transaction underlying the smart contract to be completed. Locking coins may involve placing a restriction on the use, transferability, or representation of a coin such that it may only be used for a single, preapproved purpose.

Although Smart Contract Evaluation Component 212 is shown in FIG. 3 as being part of INode 200, in some embodiments such componentry and associated functionality exists at the UNode 500 level. That is, Smart Contract Evaluation Component may exist and be executed at UNodes 500 operating within the platform. In such an embodiment Smart Contract Evaluation Component of a UNode 500 may receive information about one or more terms in a smart contract that has been accepted and digitally signed by the parties, and if necessary instructs Wallet Interaction Component (which, as discussed below, may also exist at the UNodes 500) to take an action, alone or in coordination with a given UNode's Smart Wallet Component 515. In some embodiments the one or more terms includes a payment term, and the action includes locking a number of coins in the respective UNode 500's digital wallet in an amount sufficient for the transaction underlying the smart contract to be completed. Locking coins may involve placing a restriction on the use, transferability, or representation of a coin such that it may only be used for a single, preapproved purpose. Thus, in such an embodiment, the UNode may lock up its own (or another participating party's) coins in connection with a transaction.

Wallet Interaction Component 213 receives instructions from Smart Contract Evaluation Component concerning actions to be taken with respect to a digital wallet of a UNode 500 within the blockchain networking environment. Wallet Interaction Component 213 may receive and effectuate any action with respect to a UNode's digital wallet, including by way of example, locking coins, effectuating a release or transfer of coins from one digital wallet to another digital wallet, effectuating an exchange of coins for cash, effectuating deposits, withdrawals, and so on.

Although Wallet Interaction Component 213 is shown in FIG. 3 as being part of INode 200, in some embodiments such componentry and associated functionality exists at the UNode 500 level. That is, Wallet Interaction Component may exist and be executed at UNodes 500 operating within the platform. In such an embodiment Wallet Interaction Component of a UNode 500 may receive instructions from Smart Contract Evaluation Component concerning actions to be taken with respect to a digital wallet of a UNode 500 within the blockchain networking environment. Wallet Interaction Component of a UNode 500 may receive and effectuate any action with respect to a UNode's digital wallet, including by way of example, locking coins, effectuating a release or transfer of coins from one digital wallet to another digital wallet, effectuating an exchange of coins for cash, effectuating deposits, withdrawals, and so on. Thus, in such an embodiment, the UNodes of the platform may perform any of foregoing on behalf of itself (or another participating party) in connection with a transaction.

Coin Component 214 is configured to exchange fiat currency for cryptocurrency, minting new coins as needed, and burning previously used coins as necessary. For example, a network participant associated with a UNode 500 may wish to wire cash (fiat currency) into an INode 200 controlled account in exchange for the INode 200 minting and depositing a number of coins into an account in the digital wallet of the given UNode 500 (at a predetermined rate of exchange, e.g., 1 coin deposited for each $1 USD wired). Alternatively, a network participant associated with a UNode 500 may wish to receive a cash wire (of fiat currency) from an INode 200 controlled account in exchange for releasing to the INode 200 a number of coins that the UNode 500 has acquired and secured in their digital wallet (again, at the predetermined rate of exchange, e.g., 1 coin deposited for each $1 USD wired). Coin Component 214 facilitates this exchange, alone or in connection with Wallet Interaction Component 213 of INode 200 and Smart Wallet Component 515 of a UNode 500.

Coin Component 214 may receive fiat funds from third party institutions associated with network participants. For example, a network participant may have a bank account with ABC Bank, and instruct ABC Bank to wire $100 to an account and routing number associated with an entity in control of UNode1 500-1. Upon receipt of the $100 wire, INodel 200 may, via one or more of its Coin Component 214 and Wallet Interaction Component 213, mint and/or deposit 100 coins into the digital wallet of UNode1 500-1.

Other Component(s) 215 of INode 200 may be configured to implement various other features desirable in the given environment. For example, in some contexts it will be desirable for the INode to communicate to relevant UNodes various updates concerning completion of a transaction or other metrics associated with a given transaction. For example, INode 200 may communicate and/or facilitate updates to the token or fiat balances pursuant to the completed transaction, or communicate and/or facilitate transaction statistics for/to each UNode500 that participated in a particular transaction. In some embodiments, Other Component(s) 215 may be configured to facilitate the sale of tokens held or otherwise owned by the INode 200 controlling entity (e.g., TraDove) in addition or as an alternative to minting new tokens.

FIG. 4 is an simplified block diagram illustrating an example relationship and process flow that may be implemented to facilitate a transaction between network participants associated with two different UNodes, in accordance with one or more embodiments of the present disclosure. This figure will be described, in part, with reference to an example transaction. It will be appreciated, however, that the example is provided merely for descriptive purposes, and in no way limits the technology claimed or described in the present disclosure.

As shown in FIG. 4, UNode1 500-1 is deployed on a first network participant's Device 701, and UNode2 500-2 is deployed on a second network participant's Device 702. Devices 701 and 702 may be smartphone devices, for example, and all of the UNode features described herein may be controlled via a mobile application running on each Device 701 and 702. Running complementary mobile applications for the blockchain network, UNode1 500-1 and UNode2 500-2 may be in communication over a P2P connection (such P2P connections may be established based on the participation of the INode 200 in connection with one or more UNodes 500) Exchanging information through their respective Smart Contract Components (e.g., Smart Contract Component 514-1 (not shown) of UNode1 500-1, and Smart Contract Component 514-2 (not shown) of UNode2 500-2, the smart contract components of each including features discussed herein with respect to Smart Contract Component 514 introduced in FIG. 2)), first network participant and second network participant may arrive at a proposed agreement that is acceptable by both participants, and involves a payment, e.g., of $5000 USD (equivalent to 5000 Coins) from the first network participant to the second network participant.

Upon determining that the proposed smart contract will involve payment valued at $5000 USD from the first network participant to the second network participant, Smart Contract Component 514-1 of UNode 500-1 will attempt to lock 5000 coins in UNode1 500-1's digital wallet such that, when given final approval from the parties (e.g., terms are met and both parties clicking an “agree” button), UNode2 500-2's receipt of payment from UNode1 500-1 will be guaranteed. That is, once the terms are met and both network participants provide an indication of final agreement, the smart contract component 514 of the buyer side network participant will release the agreed upon number of buyer's coins into the digital wallet of the seller, for example If there is an inadequate number of coins in UNode1 500-1's digital wallet, the smart contract term will not be met and consequently the smart contract will not be able to be approved until additional tokens are loaded into UNode1 500-1's digital wallet. In the event that, for example, the first network participant owns no coins/tokens, the first network participant must fund its digital wallet with all 5000 Coins. To do so, the first network participant may wire $5000 USD to INode 200 controlled by INode Controlling Entity 703 (e.g., TraDove), where an Exchange Rate 603 has been established such that $1 USD=1 Coin, and vice versa. Upon receipt of the first network participant's $5000 USD, INode 200 will mint and/or release 5000 Coins to the digital wallet of the first network participant, held within UNode1 500-1. Upon UNode1 500-1's digital wallet reflecting a balance of 5000 coins, the Smart Contract Component 514-1 of UNode1 500-1 will then lock the coins such that they cannot be used by UNode1 500-1, except for the purpose of satisfying payment obligations under the smart contract. Upon receiving a final approval for execution of the smart contract from both of UNode1 500-1 and UNode2 500-2, UNode 500-11 will release the 5000 coins from UNode1 500-1's digital wallet into UNode2 500-2's digital wallet. Upon UNode2 500-2's receipt of the 5000 coins from UNode1 500-1, UNode2 500-2 may request an exchange of the coins for cash with INode 200 at the established Exchange Rate 603. Upon receiving 5000 tokens from UNode1 500-1 and the completion of the transaction one or both of UNode1 500-1 and UNode2 500-12 may update INode 200 of their token balance and/or other information related to the transaction, including depersonalized information. For example, one or both of UNode 1 and UNode 2 may update INode 200 of transactions statistics such as amounts moved, countries from where the participants were participating, industries involved in or represented by in the transaction, etc.

UNode1 500-1 and/or UNode2 500-2 may utilize their respective Block Generator Components (e.g., Block Generator Component 516-1 (not shown) of UNode1 500-1, and Block Generator Component 516-2 (not shown) of UNode2 500-2, the Block Generator Components of each including features discussed herein with respect to Block Generator Component 516 introduced in FIG. 2) to write one or more new blocks of data structure for proposed entry into their respective node-specific blockchains. Although for descriptive brevity in various examples herein, a single block may represent a single transaction, it will be appreciated that block generator components of the present disclosure may in some implementations generate multiple blocks representing various facets of a single transaction. For example, block generator component 516 of a given UNode 500 may generate three blocks representing a finalized transaction, where one block is generated in connection with creation of the proposed transaction, one block is generated in connection with confirmation/agreement among the participants that the transaction can go forward as agreed, and one block is generated in connection with the settlement/completion of the payment agreed to for the transaction. Each may utilize its Po2 Consensus Component 517-1, 517-2 to decide whether or not the underlying transactions represented by the proposed block are true/valid (i.e., that each UNode that was a party to the underlying transaction sent and received what each intended to send and receive pursuant to the smart contract). Both parties may approve the new blocks of the other, and consensus may be reached pursuant to the Po2 consensus protocol. For example, the first network participant (e.g., buyer) may generate a first block representing the transaction and the second network participant (e.g., seller) may approve the block; next, the second network participant (e.g., seller) may generate a second block representing its approval, and the first network participant (e.g., buyer) approves it; next, the first network participant (e.g., buyer) may generate a third block representing the settlement/payment made, and the second network participant (e.g., seller) confirms it.

Once Po2 consensus is reached among the two network participants that were parties to the smart contract, the proposed blocks are added to the respective node-specific blockchains of each of UNode1 500-1 and UNode2 500-2.

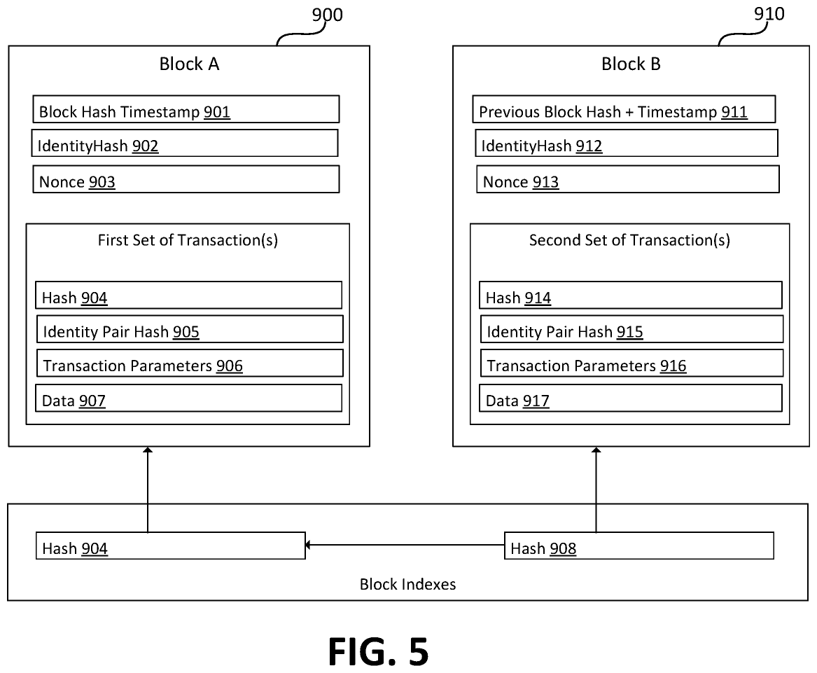

FIG. 5 illustrates an example data structure representation of the first two blocks in a node-specific blockchain. In this example, the blockchain shown is representative of the first two blocks in UNode1 500-1's blockchain. The blocks are generated at the UNode itself (e.g., by the UNode's Block Generator Component), as described herein.

As shown, a BlockA 900 (i.e., the genesis block) comprises information that is only peripherally related to the underlying transaction(s) itself/themselves, combined with information that is directly related to the underlying transaction itself.

The information that is only peripherally related to the underlying transaction(s) includes Block Hash Timestamp 901 (e.g., a hash value where part of the input to the hashing algorithm is a time associated with the block creation), an Identity Hash 902 (e.g., a hash value where part of the input to the hashing algorithm is one or more unique identifiers associated with the network participant, a Nonce 903 (e.g., an arbitrary number that can be used just once, such as a random or pseudo-random number).

The information that is directly related to the underlying transaction(s) include the Identity Pair Hash 905 (e.g., a hash value where part of the input to the hashing algorithm is a combination of the unique identifiers for both network participants who were parties to the transaction), Transaction Parameters 906 (e.g., details relating to the occurrence of the transaction, such as amounts paid, between whom, when paid, etc.), and other Data 907 (any other data that might be relevant to the transaction, and desired to be included in the block). The Hash 904 of a combination of each of the foregoing is included in the data structure of BlockA 900, and serves as the chain that links BlockA 900 with BlockB 910.

As further shown, the data structure of BlockB 910 includes hash values resulting from a combination of the previous block (BlockA) combined with the information directly related to a new transaction or set of transactions. In particular, the data structure of BlockB 910 includes the previous Block Hash 904 in combination with the new Block Hash Timestamp 911 (e.g., a hash value where part of the input to the hashing algorithm is a time associated with the prior block's hash, plus the hash of the timestamp for the new block), an Identity Hash 912 (e.g., a hash value where part of the input to the hashing algorithm is one or more unique identifiers associated with the network participant, a Nonce 913 (e.g., an arbitrary number that can be used just once, such as a random or pseudo-random number).

The data structure of BlockB 910 further includes Identity Pair Hash 915 (e.g., a hash value where part of the input to the hashing algorithm is a combination of the unique identifiers for both network participants who were parties to the transaction), Transaction Parameters 916 (e.g., details relating to the occurrence of the transaction, such as amounts paid, between whom, when paid, etc.), and other Data 917 (any other data that might be relevant to the transaction, and desired to be included in the block). The Hash 914 of a combination of each of the foregoing is included in the data structure of BlockB 910, which will serve as a chain segment that links BlockB 910 with the subsequent block.

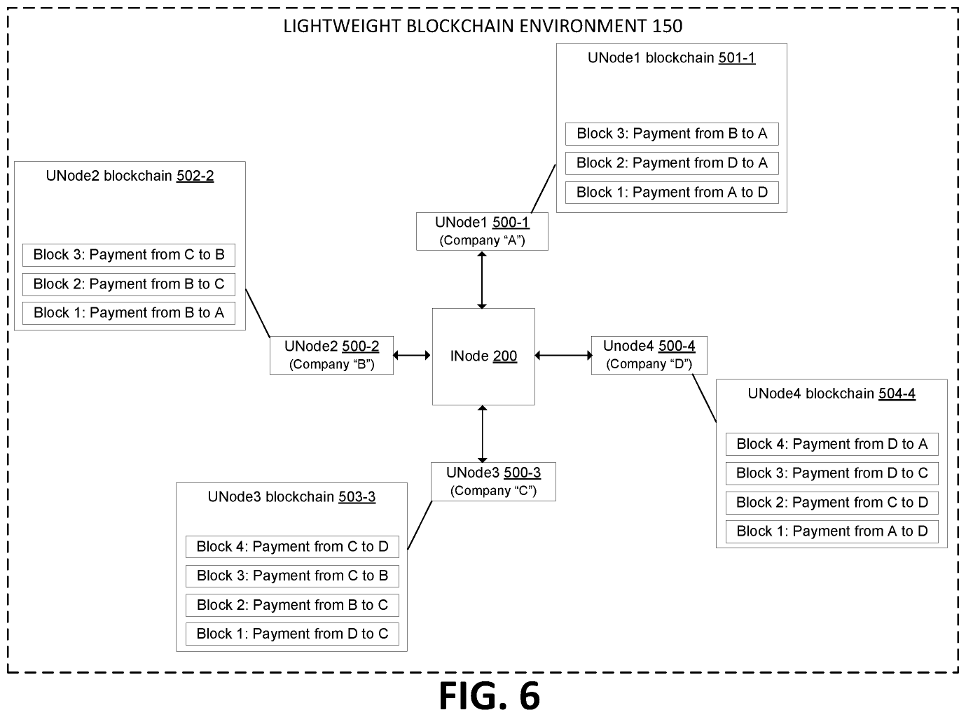

FIG. 6 illustrates one or more elements of a blockchain network environment in accordance with one or more embodiments of the present disclosure, and further illustrates a simplified view of the blockchains maintained by individual user nodes within such a blockchain networking environment. As shown, INode 200 is communicatively connected to four network participants UNode1 500-1, UNode2 500-2, UNode3 500-3, UNode4 500-4 who have transacted with one another multiple times within the blockchain network environment 150. As shown, each of UNode1 500-1, UNode2 500-2, UNode3 500-3, and UNode4 500-4 maintain respective blockchains (which main also be considered ledgers) distributed amongst themselves UNode1 Blockchain 501-1, UNode2 Blockchain 502-2, UNode3 Blockchain 503-3, and UNode4 Blockchain 504-4. As shown, the blocks in UNode1 Blockchain 501-1 only include transactions where the network participant associated with UNode1 500-1 (Company A) was a party to the transaction; the blocks in UNode2 Blockchain 502-2 only include transactions where the network participant associated with UNode2 500-2 (Company B) was a party to the transaction; the blocks in UNode3 Blockchain 503-3 only include transactions where the network participant associated with UNode3 500-3 (Company C) was a party to the transaction; the blocks in UNode4 Blockchain 504-4 only include transactions where the network participant associated with UNode4 500-4 (Company D) was a party to the transaction. INode 200 provides centralized identity management for each of network participants associated with UNode1 500-1, UNode2 500-2, UNode3 500-3, and UNode4 500-4 and may further provide updates of balances and transaction statistics of UNode 500-1, 2, 3, 4, etc. after each transaction or on a periodic basis

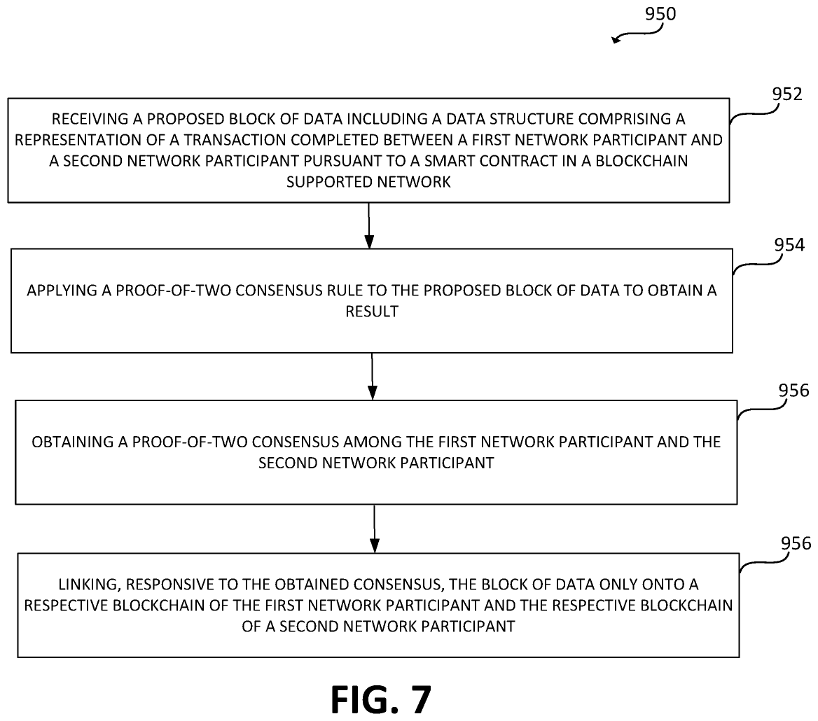

FIG. 7 illustrates an operational flow diagram illustrating an example method 950 that may be implemented to in accordance with one or more embodiments of the present disclosure. At operation 952, method 950 includes receiving a proposed block of data including a data structure comprising a representation of a transaction completed between a first network participant and a second network participant pursuant to a smart contract in a blockchain supported network. At operation 954, method 950 includes applying a proof-of-two consensus rule to the proposed block of data to obtain a result. At operation 956, method 950 includes obtaining a proof-of-two consensus among the first network participant and the second network participant. At operation 956, method 950 includes linking, responsive to the obtained consensus, the block of data only onto a respective blockchain of the first network participant and the respective blockchain of a second network participant.

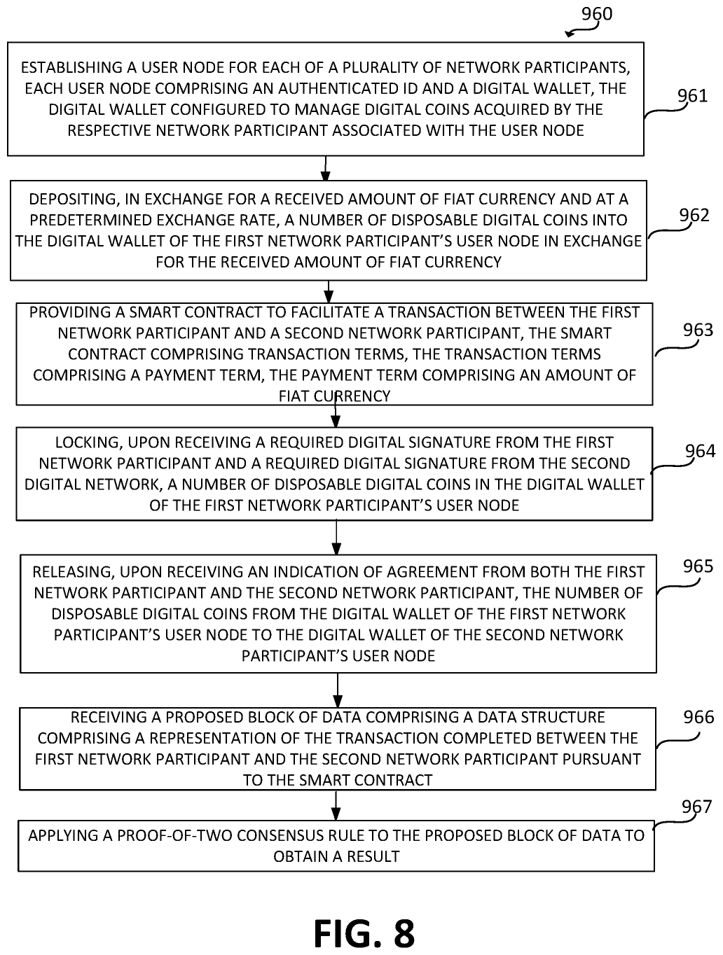

FIG. 8 illustrates an operational flow diagram illustrating an example method 960 that may be implemented to in accordance with one or more embodiments of the present disclosure. At operation 961, method 960 includes establishing a user node for each of a plurality of network participants, each user node comprising an authenticated ID and a digital wallet, the digital wallet configured to manage tokens acquired by the respective network participant associated with the user node. At operation 962, method 960 includes depositing, in exchange for a received amount of fiat currency and at a predetermined exchange rate, a number of disposable tokens into the digital wallet of the first network participant's user node. At operation 963, method 960 includes providing a smart contract to facilitate a transaction between the first network participant and a second network participant, the smart contract comprising transaction terms, the transaction terms comprising a payment term, the payment term comprising an amount of fiat currency. At operation 964, method 960 includes locking, upon receiving a required digital signature or other form of authorization from the first network participant and a required digital signature or other form of authorization from the second digital network, a number of disposable tokens in the digital wallet of the first network participant's user node. At operation 965, method 960 includes releasing, upon receiving an indication of agreement from both the first network participant and the second network participant, the number of tokens from the digital wallet of the first network participant's user node to the digital wallet of the second network participant's user node. At operation 966, method 960 includes receiving a proposed block of data comprising a data structure comprising a representation of the transaction completed between the first network participant and the second network participant pursuant to the smart contract. At operation 967, method 960 includes applying a proof-of-two consensus rule to the proposed block of data to obtain a result

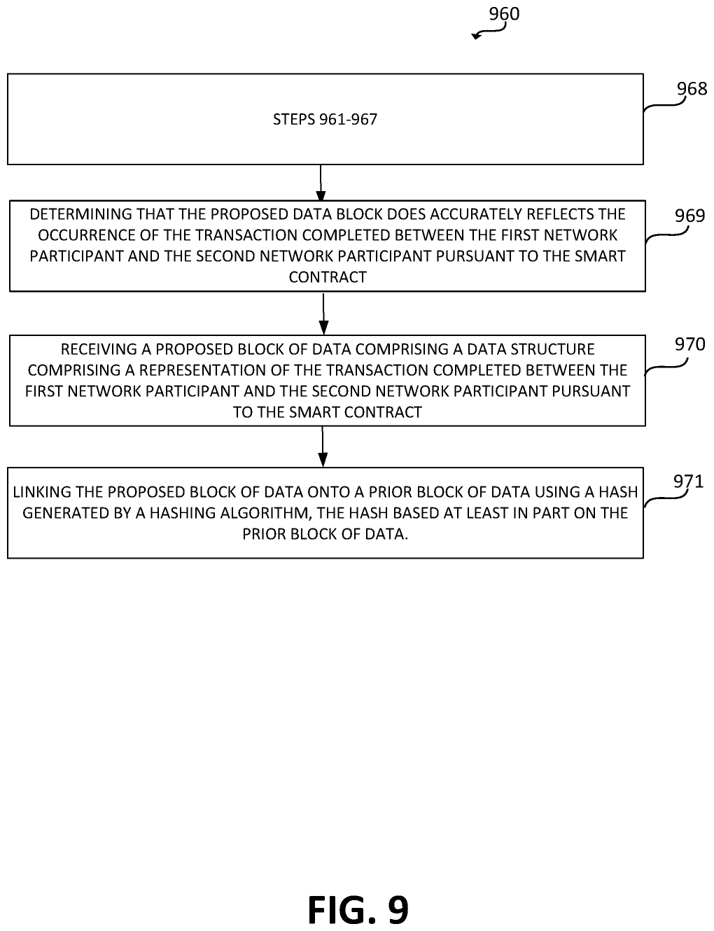

FIG. 9 illustrates an operational flow diagram illustrating additional example operations that may be implemented in connection with example method 960, in accordance with one or more embodiments of the present disclosure. At operation 968, method 960 includes determining that the proposed data block does accurately reflects the occurrence of the transaction completed between the first network participant and the second network participant pursuant to the smart contract. At operation 969, method 960 includes receiving a proposed block of data comprising a data structure comprising a representation of the transaction completed between the first network participant and the second network participant pursuant to the smart contract.

At operation 970, method 960 includes linking the proposed block of data onto a prior block of data using a hash generated by a hashing algorithm, the hash based at least in part on the prior block of data.

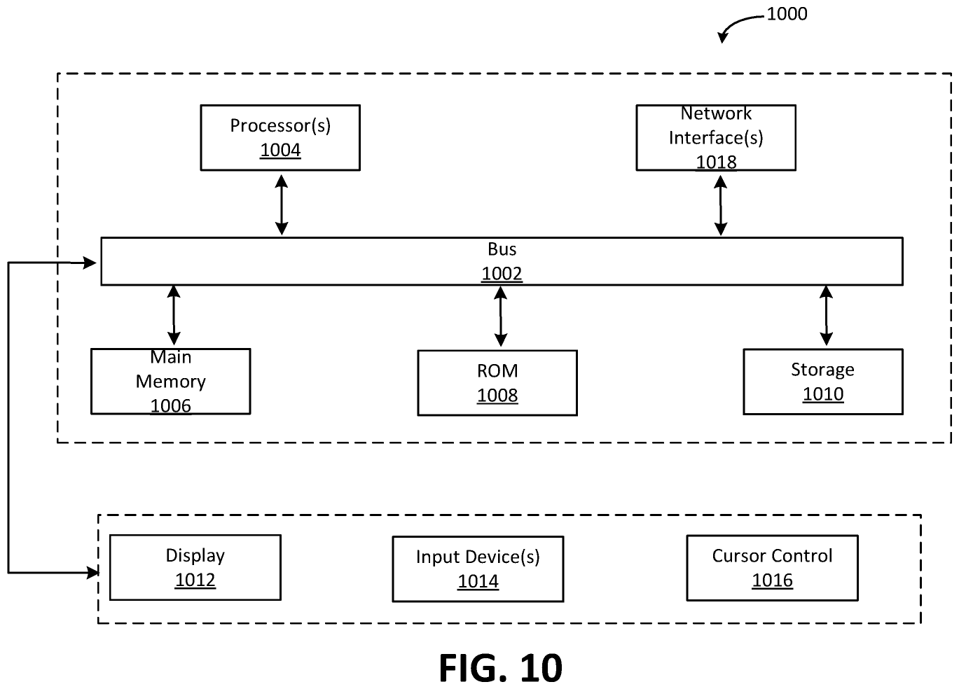

FIG. 10 depicts a block diagram of an example computer system 1000 in which various of the embodiments described herein may be implemented. The computer system 1000 includes a bus 1002 or other communication mechanism for communicating information, one or more hardware processors 1004 coupled with bus 1002 for processing information. Hardware processor(s) 1004 may be, for example, one or more general purpose microprocessors.

The computer system 1000 also includes a main memory 1006, such as a random access memory (RAM), cache and/or other dynamic storage devices, coupled to bus 1002 for storing information and instructions to be executed by processor 1004. Main memory 1006 also may be used for storing temporary variables or other intermediate information during execution of instructions to be executed by processor 1004. Such instructions, when stored in storage media accessible to processor 1004, render computer system 1000 into a special-purpose machine that is customized to perform the operations specified in the instructions.

The computer system 1000 further includes a read only memory (ROM) 1008 or other static storage device coupled to bus 1002 for storing static information and instructions for processor 1004. A storage device 1010, such as a magnetic disk, optical disk, or USB thumb drive (Flash drive), etc., is provided and coupled to bus 1002 for storing information and instructions. For enhanced security, in some embodiments storage at a UNode is embodied in ROM only.

The computer system 1000 may be coupled via bus 1002 to a display 1012, such as a liquid crystal display (LCD) (or touch screen), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. In some embodiments, the same direction information and command selections as cursor control may be implemented via receiving touches on a touch screen without a cursor.

The computing system 1000 may include a user interface component to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor(s) 1004 executing one or more sequences of one or more instructions contained in main memory 1006. Such instructions may be read into main memory 1006 from another storage medium, such as storage device 1010. Execution of the sequences of instructions contained in main memory 1006 causes processor(s) 1004 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1010. Volatile media includes dynamic memory, such as main memory 1006. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1002. Transmission media can also take the form of acoustic or light waves, such as those generated during radio-wave and infra-red data communications.

The computer system 1000 also includes a communication interface 1018 coupled to bus 1002. Network interface 1018 provides a two-way data communication coupling to one or more network links that are connected to one or more local networks. For example, communication interface 1018 may be an integrated services digital network (ISDN) card, cable modem, satellite modem, or a modem to provide a data communication connection to a corresponding type of telephone line. As another example, network interface 1018 may be a local area network (LAN) card to provide a data communication connection to a compatible LAN (or WAN component to communicated with a WAN). Wireless links may also be implemented. In any such implementation, network interface 1018 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 1018, which carry the digital data to and from computer system 1000, are example forms of transmission media.

The computer system 1000 can send messages and receive data, including program code, through the network(s), network link and communication interface 1018. In the Internet example, a server might transmit a requested code for an application program through the Internet, the ISP, the local network and the communication interface 1018. The received code may be executed by processor 1004 as it is received, and/or stored in storage device 1010, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

As used herein, the term “node-independent blockchain” refers to a blockchain that is accessible to any node on a blockchain network, and where any node is eligible to participate in the consensus process. A “node-independent blockchain” may also be referred to herein as a “conventional blockchain.”

As used herein, the term “node-specific blockchain” refers to a blockchain maintained by an individual node that only includes blocks of transactions involving the network participant associated with the individual node. Only a subset of trusted nodes involved in a given transaction may participate in the consensus process for the addition of a subsequent block onto a node-specific blockchain. The right to view a node-specific blockchain maintained by a given node may be restricted to those trusted nodes that participate in a transaction with the given node. The right of such a trusted node to view a node-specific blockchain of the given node may further be restricted in time, based on the timing of a given transaction.

As used herein, the term “centralized identity” refers to a user profile of a trusted network participant that is maintained by a centralized node (e.g., the INode). The centralized identity is associated with a true identity of a network participant corresponding to a particular node (e.g., a particular UNode) within the blockchain networking environment of the present disclosure. The centralized identity may comprise any form of identifying information, such as a username, an email address, a code, etc.

As used herein, the terms “cryptocurrency” and “coin” are used interchangeably in the present disclosure, and generally refer to any tradable digital asset or digital form of currency that uses cryptography to verify and secure transactions. The transaction records embodied in the blockchain of the present disclosure can include transactions involving cryptocurrency.

As used herein, the term “hashing” is the process of taking an input and turning it into a cryptographic fixed output through a mathematical algorithm (e.g., Message Digest 5 (“MD5”), Secure Hash Algorithm (“SHA”)), for example). The output of the hashing process is referred to herein as a “hash,” and is the value returned by the mathematical algorithm based on the given input. An input can include a piece of information such as a message, a unit of data, or a cache of varying pieces of information such as a block of transactions. An input may be of an any size.

As used herein, the term “genesis block” refers to the first block of a blockchain. A genesis block can be generated by using an original set of transactions (and/or other information) which, when combined and provided as an input to a hashing process to produce a unique, original hash. Upon the occurrence of one or more new transactions (or at predetermined intervals), the original hash can be combined with the new transaction information, which can then be used as the new input to the hashing algorithm to create a brand new hash that is used to link the next block in the chain (creating a “blockchain”). Ultimately, each block in a blockchain links back to its previous block through its hash, forming a chain back to the original genesis block. For example, in embodiments of the technology of the present disclosure, transactions can be added securely as long as required nodes on the network are in consensus on what the hash should be pursuant to the Po2 Consensus Protocol.

For purposes of description the present disclosure has been explained in terms of two network participants transacting in a unique blockchain environment using, inter alia, a Proof-of-two (Po2) consensus protocol. It should be understood however that the examples provided herein should not be understood to limit the present disclosure to such embodiments. For instance, in implementations of the present technology that support transactions between more than two parties in a single transaction (e.g., a three party transaction, a five party transaction, an N-party transaction), the technology of the present disclosure may be modified to operate with a consensus protocol involving all of the participating parties (e.g., a proof-of-3 (Po3) protocol, a proof-of-5 (Po5) protocol, or, more generally, a proof-of-N (PoN) protocol where “N” represents the number of network participants that are parties to a given transaction.

Although various embodiments of the present disclosure are discussed herein in the context of blockchains, it should be understood that all such embodiments can be equally applied to distributed ledger technologies, or any modifications or variations thereon. For example, to the extent an embodiment is described in the context of a blockchain network, it should be appreciated that the embodiment may more generally be applied in a distributed ledger network.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A system for processing transactions in a blockchain supported network, the system comprising:
one or more processors; and
one or more memory devices storing instructions that, when executed by the one or more processors, cause the system to perform operations of:
establishing a user node for each of a plurality of network participants, each user node comprising an authenticated ID and a digital wallet, the digital wallet configured to manage tokens acquired by the respective network participant associated with the user node;
depositing, in exchange for a received amount of fiat currency and at a predetermined exchange rate, a number of tokens into the digital wallet of the first network participant's user node in exchange for the received amount of fiat currency;
providing a smart contract to facilitate a transaction between the first network participant and a second network participant, the smart contract comprising transaction terms, the transaction terms comprising a payment term, the payment term comprising an amount of fiat currency;
locking, upon receiving a required digital signature or other form of authorization from the first network participant and a required digital signature or other form of authorization from the second digital network, a number of tokens in the digital wallet of the first network participant's user node;
releasing, upon receiving an indication of agreement from both the first network participant and the second network participant, the number of tokens from the digital wallet of the first network participant's user node to the digital wallet of the second network participant's user node;
receiving a proposed block of data comprising a data structure comprising a representation of the transaction completed between the first network participant and the second network participant pursuant to the smart contract; and
applying a proof-of-two consensus rule to the proposed block of data to obtain a result.

2. The system of claim 1, wherein the one or more memory devices store instructions that, when executed by the one or more processors, further cause the system to perform operations of:
determining if the proposed block of data accurately reflects the occurrence of the transaction completed between the first network participant and the second network participant pursuant to the smart contract.

3. The system of claim 2, wherein the one or more memory devices store instructions that, when executed by the one or more processors, further cause the system to perform operations of:
obtaining an indication of consensus, wherein the indication of consensus signifies that the first and second network participants applied the same proof-of-two consensus rule to the same proposed block of data and arrived at the same determination.

4. The system of claim 3, wherein the determination was that the proposed data block does accurately reflects the occurrence of the transaction completed between the first network participant and the second network participant pursuant to the smart contract.

5. The system of claim 4, wherein the one or more memory devices store instructions that, when executed by the one or more processors, further cause the system to perform operations of:
linking the proposed block of data onto a prior block of data using a hash generated by a hashing algorithm, the hash based at least in part on the prior block of data.

6. The system of claim 2, wherein the one or more memory devices store instructions that, when executed by the one or more processors, further cause the system to perform operations of:
generating a block of data comprising a data structure comprising a representation of the transaction completed between the first network participant and the second network participant pursuant to the smart contract.

7. The system of claim 2, wherein the one or more memory devices store instructions that, when executed by the one or more processors, further cause the system to perform operations of:
applying a hash algorithm to a subset of information, the subset of information comprising a hash value of a previously generated block of data.

8. The system of claim 7, wherein the subset of information further comprises a transaction parameter of the transaction completed between the first network participant and the second network participant pursuant to the smart contract.

9. The system of claim 1, wherein the one or more memory devices store instructions that, when executed by the one or more processors, further cause the system to perform operations of:
receiving a number of tokens from the second network participant's user node;
depositing into an account associated with the second network participant, in exchange for the received amount of tokens from the second network participant's user node and at the predetermined exchange rate, an amount of fiat currency corresponding to the number of tokens received from the second network participant's user node.

10. A method, comprising:
establishing an account for each of a plurality of network participants, each account comprising an authenticated ID and a digital wallet, the digital wallet configured to manage tokens acquired by the respective network participant associated with the account;
receiving an amount of fiat currency from a first network participant;
depositing, in exchange for the received amount of fiat currency and at a predetermined exchange rate, a number of tokens into the digital wallet of the first network participant in exchange for the received amount of fiat currency;
providing a smart contract to facilitate a transaction between the first network participant and a second network participant, the smart contract comprising transaction terms, the transaction terms comprising a payment term, the payment term comprising an amount of currency, wherein the amount of currency is given in one or more of fiat currency units or disposable token units;
determining, based on the payment term, a number of tokens to be moved from the first network participant's digital wallet into the second network participant's digital wallet to complete the transaction;
locking, upon receiving a required digital signature or other form of authorization from the first network participant and a required digital signature or other form of authorization from the second digital network, a number tokens in the digital wallet of the first network participant, the number of tokens locked being sufficient to satisfy the payment term of the smart contract;
releasing, upon receiving an indication of consensus from both the first network participant and the second network participant, a number of disposable tokens sufficient to satisfy the payment term of the smart contract from the digital wallet of the first network participant to the digital wallet of the second network participant;
unlocking, upon completion of the release of the disposable tokens to the digital wallet of the second network participant, the disposable tokens in the digital wallet of the second network participant.

11. The method of claim 11, further comprising:
receiving a number of tokens from the second network participant;
depositing into an account associated with the second network participant, in exchange for the received amount of token from the second network participant and at the predetermined exchange rate, an amount of fiat currency corresponding to the number of disposable tokens received from the second network participant.

12. The method of claim 12, further comprising:
receiving a proposed block of data comprising a data structure comprising a representation of the transaction completed between the first network participant and the second network participant pursuant to the smart contract;
applying a proof-of-two consensus rule to the proposed block of data to obtain a result.

13. The method of claim 13, further comprising:
determining if the proposed block of data accurately reflects the occurrence of the transaction completed between the first network participant and the second network participant pursuant to the smart contract.

14. The method of claim 14, further comprising:
obtaining an indication of consensus, wherein the indication of consensus signifies that the first and second network participants applied the same proof-of-two consensus rule to the same proposed block of data and arrived at the same determination.

15. The method of claim 15, wherein the determination was that the proposed data block does accurately reflects the occurrence of the transaction completed between the first network participant and the second network participant pursuant to the smart contract

16. The method of claim 16, further comprising:
linking the proposed block of data onto a prior block of data using a hash generated by a hashing algorithm, the hash based at least in part on the prior block of data.

17. The method of claim 12, further comprising:
generating a block of data comprising a data structure comprising a representation of the transaction completed between the first network participant and the second network participant pursuant to the smart contract.

18. The method of claim 11, further comprising:
applying a hash algorithm to a subset of information, the subset of information comprising a hash value of a previously generated block of data.

19. The method of claim 11, wherein the subset of information further comprises a transaction parameter of the transaction completed between the first network participant and the second network participant pursuant to the smart contract.

20. A method comprising:
receiving a proposed block of data including a data structure comprising a representation of a transaction completed between a first network participant and a second network participant pursuant to a smart contract in a blockchain supported network;
applying a proof-of-two consensus rule to the proposed block of data to obtain a result;
obtaining a proof-of-two consensus among the first network participant and the second network participant;
linking, responsive to the obtained consensus, the block of data only onto a respective blockchain of the first network participant and the respective blockchain of a second network participant; and
wherein the consensus obtained is not from a majority of user nodes in the blockchain supported network.
